(19) United States
(12) Patent Application Publication
(10) Pub. No.: US 2014/0304065 A1
(43) Pub. Date: Oct. 9, 2014

(54) Tracking On-Line Advertisement Exposure Via Mobile Wireless Device Browsers

(71) Applicant: DynamicLogic, LLC, Wilmington, DE (US)

(72) Inventors: Ronit Aviv, New York City, NY (US); Peter Dietrich, Elmhurst, NY (US); Shimon Schwartz, Brooklyn, NY (US)

(73) Assignee: DynamicLogic, LLC, Wilmington, DE (US)

(21) Appl. No.: 14/244,491

(22) Filed: Apr. 3, 2014

Related U.S. Application Data
(60) Provisional application No. 61/807,953, filed on Apr. 3, 2013.

(51) Int. Cl. G06Q 30/02

(52) U.S. Cl. CPC G06Q 30/0245
USPC 705/14.44

(57) ABSTRACT

A system and method are described for tracking on-line advertisement exposure information for particular user devices. Alternative approaches are proposed as alternatives to using cookies on user devices to maintain a summary of previous on-line advertisement exposure. A survey participant server maintains a database including elements containing the summary of previous on-line advertisement exposure, each element being associated with a unique identifier value assigned to a particular user device. Such information is subsequently used to administer on-line surveys presented to users via the user devices.

### CROSS-REFERENCE TO RELATED PROVISIONAL APPLICATION

This patent application is the nonprovisional of U.S. Provisional Application Ser. No. 61/807,953, filed Apr. 3, 2013, entitled “Tracking On-Line Advertisement Exposure Via Mobile Wireless Device Browsers,” the contents of which are expressly incorporated herein by reference in their entirety, including any references therein.

### TECHNICAL FIELD

The invention generally relates to systems and methods for gauging on-line advertisement campaign effectiveness. More particularly, the disclosure herein relates to effectively maintaining a record of user exposure to on-line advertisements via mobile wireless device browsers. Such information is used by integrated networked systems to selectively present on-line surveys to on-line users (both previously exposed to particular ads and “control” groups who have no previous exposure to particular ads relating to a survey).

### BACKGROUND

The Internet can be an effective forum for advertising. Use of the Internet for a variety of personal and professional uses has increased considerably, and such increase shows no signs of stopping. Many on-line content and service providers rely upon sponsors to support their ongoing activities. Today, it is very common for viewers of web sites'to view a variety of downloaded and displayed (on-line) advertisements. Without such sponsor support, many of the provided on-line sites would not exist—or at least not operate at a high quality level—without sponsor support.

Moreover, many on-line advertisers rely upon associated on-line advertisement surveys to gauge effectiveness of particular on-line advertising campaigns. Using on-line surveys to gauge effectiveness of particular on-line advertisement campaigns involves, for example surveying on-line participants taken from a first population exposed to the on-line advertisement and a second population that was not exposed to the on-line advertisement. The responses from the two distinct populations are thereafter compared to determine the effect of the advertising campaign on the exposed population.

The above-summarized methodology for gauging on-line advertisement campaign effectiveness relies heavily upon establishing and thereafter accessing information accurately identifying previous exposure by survey participants to on-line advertisements. An inability to distinguish survey participants that viewed a particular on-line advertisement (i.e. the exposed group) from other survey participants that have not viewed the on-line advertisement (i.e. the control group) could greatly reduce the value of such surveys and prevent accurate assessment of the value of on-line advertising campaigns. Lacking the ability to gauge effectiveness of on-line advertisement, potential sponsors are less likely to invest in this mode of advertisement.

Identifying devices that previously received and displayed particular on-line advertisements is facilitated, for example, by modifying a file on a user device (e.g., a cookie) when a particular on-line advertisement is played, the modified file includes one or more elements identifying information relating to previously executed/displayed on-line advertisements. Use of cookies is less desirable in certain environments where either cookie data is frequently deleted to maintain adequate memory space on a device where downloadable advertisements are potentially executed/displayed.

Maintaining on-line advertisement exposure on mobile wireless devices presents a variety of challenges. One potential challenge is identifying a particular user since mobile wireless devices may not be identifiable by a unique identifier (e.g. a permanent IP address). Moreover, some mobile devices do not support a variety of technologies upon which the above cookie-based on-line survey scheme is based. Such technologies include: third party cookies, java scripts, and limited browser application functionality.

Another challenge is to properly identify particular users of a same device that downloads and executes on-line advertisements. In the case of multi-user devices, a first user may thus view of downloaded on-line advertisement and a second user of the same device may be invited to take a survey using the device.

An advertisement exposure data storage and survey administration method is described in U.S. Pat. No. 7,010,497, entitled “SYSTEM AND METHOD FOR EVALUATING AND/OR MONITORING EFFECTIVENESS OF ON-LINE ADVERTISING.” The method described therein involves determining whether a user has been exposed to an on-line ad campaign by checking cookies stored on the user's computer. Based, at least in part, on this determination, a decision is made as to whether or not to solicit the user to take an on-line survey.

U.S. patent application Ser. No. 09/900,674, filed Jul. 6, 2001, entitled “Method and System for Conducting An On-Line Survey,” describes yet another way to carry out on-line surveys. In that system, in response to receiving a request for a block of data from a user's computer, a determination is made whether the user has previously been solicited to take an on-line survey. Thereafter, computer-readable instructions are returned with the requested block of data that facilitate invoking a procedure for soliciting the user to take an on-line survey.

Successfully carrying out systems for downloading on-line advertisements for execution on a variety of machines (including mobile wireless devices), and thereafter executing on-line surveys completed by both exposed and control groups of users, is dependent upon maintaining accurate records of identified user exposure to such advertisements and subsequent completion of surveys by such identified users.

### SUMMARY OF THE INVENTION

A method and system for tracking on-line advertisement exposure of mobile wireless device users is described herein. The disclosure contained herein describes operation of a networked system for administering on-line advertisement campaigns on a network including a user device having a unique identification (UID), a survey participant server and an advertisement server. Such administrative operation includes creating, on the survey participant server, a database element associated with the UID of the user device, the database element including information corresponding to on-line advertisements previously executed on the user device. The survey participant server is configured to receive an on-line advertisement exposure notification from the user device. The on-line advertisement exposure notification includes the UID and an on-line advertisement ID corresponding to an on-line advertisement provided by the advertisement server. The survey participant server is further configured to update the database element associated with the UID in accordance with advertisement exposure on the user device associated with the on-line advertisement ID.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an example network environment in which an embodiment of the invention is used;

FIG. 2 generally identifies portions of an exemplary on-line advertisement including a tracking tag;

FIG. 3 is a flowchart depicting a set of exemplary steps for downloading and processing a Web page including an on-line advertisement block including an on-line advertisement and tracking tag; and

FIG. 4 is a flowchart depicting a set of exemplary steps for downloading and processing a Web page including an on-line advertisement block including a survey solicitation and survey recruitment tag.

### DETAILED DESCRIPTION OF THE DRAWINGS

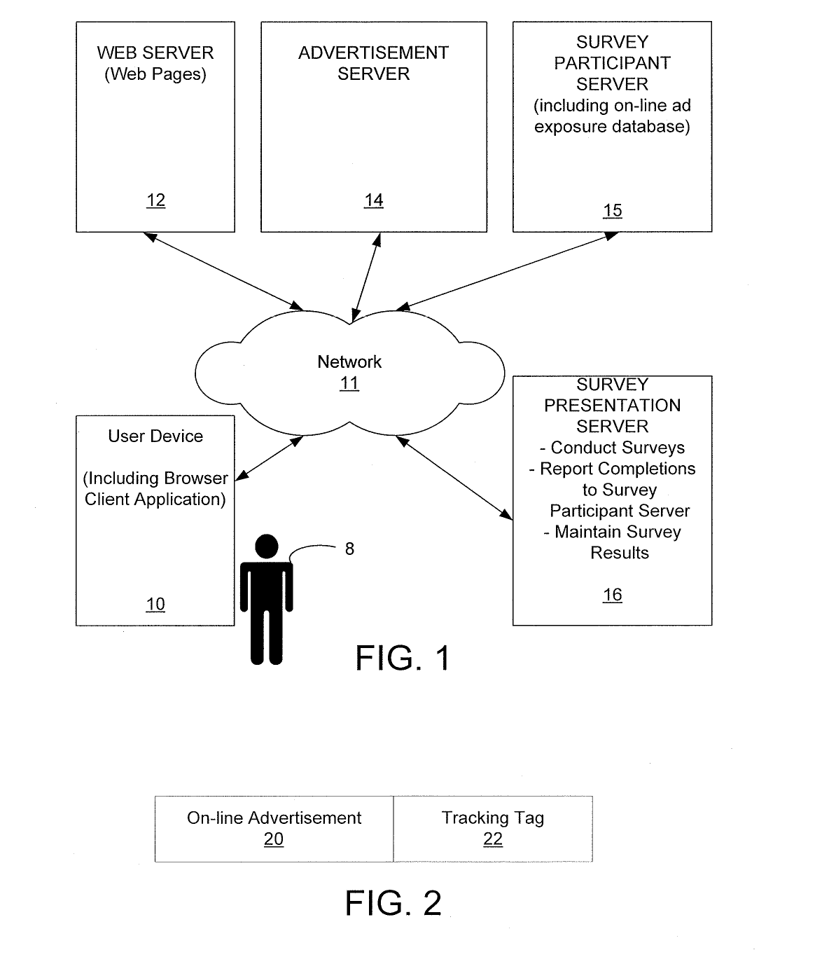

Turning to FIG. 1, an exemplary general network environment is depicted that is suitable for carrying out an on-line ad campaign with associated recruitment and execution of a survey related to the on-line advertisement campaign. More particularly, in accordance with an exemplary embodiment, the network environment supports a variety of user identification, on-line advertisement exposure recordation, and survey administration schemes to accommodate an increasing use of mobile wireless devices to carry out browsing over the Internet.

The exemplary network environment includes a Web server 12 that, upon request from a user device 10, downloads Web pages to the user device 10. In the exemplary network environment the user device 10 is associated with a user 8 and executes a browser client application through which the user 8 requests and receives, via the user device 10, a Web page from the Web server 12.

A Web page delivered by the Web server 12 to the user device 10 via the network 11 includes page content (e.g., a requested news article) and advertisement code. The Web page is processed by the browser client application on the user device 10 after receipt by the user device 10. Processing the advertisement code (e.g., Java scripts or other instruction encoding form), by the browser client on the user device 10, results in the issuance of a request by the user device 10 to an Advertisement server 14 for an online advertisement block. The advertisement server 14 thereafter provides an on-line advertisement block (e.g., a combination of HTML and Java scripts) including an on-line advertisement 20 portion and a tracking tag 22 (see FIG. 2) for execution on the user device 10. The on-line advertisement block thus includes executable instructions/code that, when processed by the user device 10 cause the user device 10 to: (1) display an on-line advertisement and (2) record the user's exposure to the downloaded on-line advertisement.

By way of example, instructions within the on-line advertisement block from the advertisement server 14, when executed by the browser on the user device 10, cause the browser to issue a request to a survey participant server 15 (including an on-line ad exposure database). The request to the survey participant server 15 includes header information and passed parameters (specified, for example, in a URL that identifies the server 15 to the browser), that determine the content of the server 15's response. In an exemplary embodiment, the tracking tag 22 includes a unique identifier (UID) for the user device 8.

The aforementioned instructions executed by the browser to issue a request to the server 15 can be specified by the tracking tag 22 in any of a number of (direct/indirect) ways. In an exemplary embodiment, the tracking tag 22 is a JavaScript instruction containing a reference (e.g., a URL) to a file containing the instructions to be executed by the browser. Alternatively, the tracking tag 22 includes the instructions to be executed by the browser on the user device 10 (thereby avoiding a further call to a server maintaining the file containing the executable instructions).

In an exemplary embodiment, the browser on the user device 10, in response to executing the instructions associated with the tracking tag 22, issues an HTTP request to the survey participant server 15. The HTTP request includes a URL identifying: (1) the server 15, (2) the advertisement (on-line advertisement 20) creative with which the request is associated, and (3) the placement (size and location) of the advertisement on the browser's graphical user interface. Though the illustrative example uses a URL to convey the above-described information from the user device 10 to the survey participant server 15, in alternative embodiments the information is provided in alternative message structures.

The HTTP request by the user device 10 to the server 15, in the case where cookies are supported, may also include a header identifying each cookie on the user device 10 corresponding to the domain of the survey participant server 15. Thus, prior to issuing the request to the server 15, the browser on the user device 10 may search for responsive cookies on the user device 10. The responsive cookies include at least ones potentially pertaining/relating to previous presentation by the browser of an advertisement relating to an ad campaign associated with the downloaded on-line advertisement 20. The use of the header of the HTTP request to convey ad exposure information to the server 15 is exemplary. On-line advertisement exposure by particular user devices, such as user device 10, is conveyed in alternative message structures in accordance with other embodiments—particularly in the case where the user device 10 does not support cookies.

Thus, in an exemplary embodiment, instructions specified (directly/indirectly) by the tracking tag 22 cause the user device 10's browser to contact the survey participant server 15 to initiate a procedure for determining whether to create/store a UID corresponding to the user device 10. In an exemplary embodiment, the survey participant server 15 centrally maintains/administers a database of registered users (user devices), identified by UIDs, and associated advertisement campaign exposure (including completed surveys).

The described functionality of the survey participant server 15 is implemented, in executable software modules and hardware, in potentially many different ways in accordance with alternative embodiments. The survey participant server 15, while illustrated as a single entity in FIG. 1, can in fact be implemented as multiple distinct servers at distinct network addresses. There is no intention to limit the manner in which the functionality of the survey participant server 15 is carried out in server software and hardware. In another illustrative embodiment, the functionality of the survey participant server 15 is embodied in multiple distinct server applications that reside at a same network address.

A survey presentation server 16 is configured to carry out a variety of functions relating to administering completion of surveys by users, such as user 8 of user device 10. The survey presentation server 16 is configured to administer conducting actual surveys, reporting completions of such surveys, and maintaining survey results. The survey presentation server 16, while illustrated as a single entity in FIG. 1, can in fact be implemented as multiple distinct servers at distinct network addresses. There is no intention to limit the manner in which the functionality of the survey presentation server 16 is carried out in server software and hardware. In another illustrative embodiment, the functionality of the survey presentation server 16 is embodied in multiple distinct server applications that reside at a same network address.

Historically, the user device 10 is typically a computer (e.g., desktop, laptop, netbook) connecting to the Internet via a wired or local wireless connection. However, more recently, the user device 10 is often a mobile wireless device (e.g., smart phone, tablet computer) connecting to the Internet via a mobile wireless data network. Substantial differences between the operating systems and networking protocols used by mobile wireless devices on the one hand, and computers (e.g., desktop, laptop, netbook) on the other hand, lead to a need to develop multiple schemes for carrying out on-line advertisement campaigns, recording on-line advertisement exposure by users, and administering on-line surveys relating to the on-line advertisement campaigns. One particular example is the presence of browser application extensions typically found on computers that facilitate executing JavaScript associated with Web pages downloaded from the Web server 12 via a network 11 (e.g., the Internet). Such JavaScript extensions are often not supported/present on mobile wireless devices. As such, a multi-pronged multi-scheme approach to on-line advertisement administration is described herein.

Having described an exemplary network environment for carrying out an exemplary embodiment of the present invention, attention is directed to a group of schemes for administering on-line advertisement campaign exposure by users and survey invitations/completions. It is initially noted that in cases where the user device 10 supports a legacy scheme described in Nyhan et al. U.S. Pat. No. 7,010,497 wherein JavaScripts are supported and the user device 10 permits storing information within cookies relating to on-line advertisement exposure and survey invitations/completions, then each of the approaches described below can be disregarded (or alternatively used to augment the functionality of the legacy scheme).

However, in cases where the user device 10 does not support the legacy scheme that is based upon storing information within cookies on the user device 10, then one or more of the following set of supplemental schemes are potentially relied up to generate and maintain advertisement exposure information for particular identified entities. Such instances typically arise in the context of mobile wireless devices, such as smart phones, that do not support JavaScripts and/or cookies. In each of the approaches, described herein below, for administering on-line advertisement campaigns and related surveys for user devices that do not support the legacy cookie-based on-line advertisement campaign administration scheme, the aim is to:
(1) obtain a “unique identifier” (referred to herein as UID) for the user 8 of the user device 10, the UID being used by an on-line advertisement administration system to store on-line advertisement exposure information in a database (including a file element in a file system storing on-line ad exposure for identified users); and
(2) pass the UID to a survey engine of the on-line advertisement administration system when the user opts to take a survey.

A first alternative approach is based upon using a “browser cache” for locally storing information (available to all browsers on the user device 10) linking the user device 10 to a historical summary, maintained by the survey participant server 15, of previous on-line advertisement exposure and related survey information. The browser cache approach is characterized by the following functionality. A UID value corresponding to the user device 10, if not already stored in the user device 10 browser cache, is created and stored in the browser cache of the user device 10. The UID value is also stored on the survey participant server 15 along with exposure (and survey) information. Thereafter, the UID value is passed by the device 10 to the server 15 to indicate an executed on-line advertisement, resulting in updating a record of on-line advertisement exposure by the device 10 within an entry (element) of the server 15 database corresponding to the UID assigned to the device 10. Moreover, the same UID is used to identify the user device 10 when the user 8 accepts a solicitation to take a survey relating to an on-line advertisement campaign. A survey engine on the server 15 reads the UID from the browser cache of the user device 10 and retrieves exposure information from the database of the survey participant server 15.

A second alternative approach is based upon a “local storage” on the user device 10 to store the above-described UID value for the user device 10. The “local storage” differs from the “browser cache” in that the “browser cache” is a legacy structure on devices that is accessible by all browser versions that may run on the user device 10 and includes ordinary file system files. In contrast, the “local storage”—supported by newer browsers—operates more like a small database that supports access via name-value pairs of data. The “local storage” approach uses the UID to uniquely identify the user device 10. However, the “local storage” database is generally regarded as having greater persistence than the aforementioned “browser cache,” and the associated database entries in the “local storage” will persist between browser sessions (which otherwise may be subject to flushing in the case of the browser cache).

A third alternative approach is based upon use of a unique ID used by an on-line advertisement server (e.g., advertisement server 14) to identify a particular user device. The third alternative approach is similar to the first alternative approach. However, the source of the UID is the on-line advertisement server instead of the survey participant server 15. On-line advertisement servers for mobile wireless devices may utilize a unique identifier to be used for targeting particular users. The UID is generated by the on-line advertisement server 14 and passed by the on-line advertisement server 14 to the survey participant server 15 for purposes of: (1) creating a record of on-line advertisement exposure by the user device 10 to ads provided by the advertisement server 14 and, (2) incorporation into the tracking tag 22 provided in the downloaded on-line advertisement block. The survey participant server 15 stores, in the database, the UID provided by the on-line advertisement server 14 along with exposure information for the user device 10 upon which the on-line advertisement was executed. Some of the on-line advertisement messages issued by the advertisement server 14 to the user device 10 are survey recruitment solicitations (e.g. ‘please click here to take a survey’). The on-line advertisement server 14 passes the UID to a ‘survey click-thru url’ contained in the on-line advertisement message downloaded to the user device 10. When the user 8 clicks on the on-line advertisement, the resulting request from the user device 10 to the survey participant server 15 containing the UID causes the survey engine on the survey participant server 15 to retrieve on-line advertisement exposure information corresponding to the provided UID (i.e., the on-line ad exposure of the user device 10).

A fourth alternative approach is based upon use of a telecom company unique identifier assigned to the user device 10. In some cases, mobile wireless telecom companies have access to a UID for the user device 10 (mobile wireless device) and control the functionality of the browser installed on the user device 10. The UID assigned by the telecom company to the user device 10 is thereafter included in the http header of each request message issued by the browser of the user device 10. In an illustrative embodiment, executable instructions associated with the tracking tag 22 in an on-line advertisement block provided by the advertisement server 14 cause the browser on the user device 10 to issue a request message to the survey participant server 15 that, in turn, reads the header containing the UID assigned to the user device 10 by the telecom company. The survey participant server 15 stores the UID and identified on-line advertisement exposure information in a database element corresponding to the telecom company-assigned UID. When the user 8 of the user device 10 is invited to take an on-line survey via a survey recruitment advertisement message, the survey engine reads the http header including the UID and retrieves exposure information from the database.

When the user 8 clicks on a survey solicitation provided in association with a received on-line advertisement message, the http header of the resulting request message from the user device 10 to the survey participant server 15 contains the UID assigned by the telecom company to the user device 10. The survey engine on the survey participant server 15 used the UID assigned by the telecom company to the user device 10 to retrieve on-line advertisement exposure information corresponding to the provided UID (i.e., the on-line ad exposure of the user device 10).

A fifth alternative approach is based upon use of a UID available on the user device 10 and is unique to that particular device. In the case of a mobile wireless device, the user device 10 provides on-line applications access to such UID on the user device 10. The device-specific UID is thereafter utilized in a way analogous to the above-described approach for unique IDs assigned by telecom companies and advertisement servers to particular user devices.

As can be seen by the above examples, a variety of alternative approaches are potentially adopted to address potential problems arising from limited cookie storage facilities in user devices—particularly in the case of mobile wireless devices.

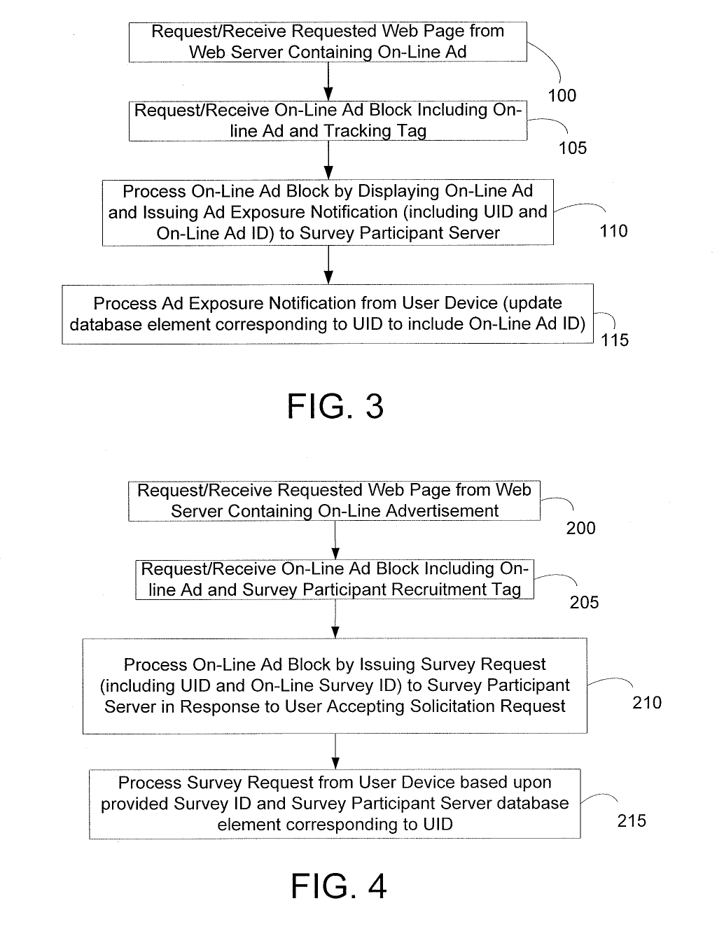

Having described an exemplary network environment and a set of illustrative alternatives to cookie-based tracking of user exposure to on-line advertisements downloaded and executed on the user device 8, attention is directed to FIGS. 3 and 4 that summarize a generalized approach for administering on-line advertisement campaigns in an environment where the user device 8 (e.g., a mobile wireless device) does not locally store on-line ad exposure in a local file (e.g., a cookie) and instead relies upon such storage to occur on the survey participant server 15.

Turning first to FIG. 3, steps are summarized that are associated with the general process of recording, by the survey participant server 15, on-line advertisements executed/displayed on the user device 8. Initially, during step 100, the browser running on the user device 10 requests and receives a requested Web page from the Web server 12. The received Web page includes code (advertisement tag) identifying a source for an on-line advertisement block from the advertisement server 14. By way of example, the on-line advertisement block includes the on-line advertisement 20 portion and the tracking tag 22 (discussed above with reference to FIG. 2).

In the exemplary embodiment, during step 105, the browser processes the Web page containing the advertisement tag and requests/receives the on-line advertisement block, from the advertisement server 14, containing the on-line advertisement 20. In an alternative embodiment, instead of an advertisement tag (referencing a source of the actual on-line ad code); the Web page from the Web server 12 contains actual instructions for presenting the on-line advertisement on the browser's user interface and tracking on-line ad exposure. Those skilled in the art will appreciate the many alternatives for specifying an on-line advertisement within a Web page downloaded to the browser.

After receiving the on-line advertisement block, during step 110, the browser on the user device 10 commences processing the requested/received on-line ad block. The processing of the on-line advertisement 20 of the advertisement block by the browser on the user device 10 results in presentation of an on-line advertisement (“creative”) within an area corresponding to a specified placement. Processing the on-line advertisement 20 portion of the on-line ad block is well known to those skilled in the art and will not be discussed in detail herein.

Additionally, during step 110, to accommodate a need to reliably store ad exposure of particular user devices, the user device 10 processes the tracking tag 22 and issues an on-line ad exposure notification to the survey participant server 15. The ad exposure notification includes: (1) the UID associated with the user device 10, and (2) the on-line ad ID.

Thereafter, during step 115 the survey participant server 15 processes the on-line ad exposure notification from the user device 10. Such processing includes, among other things, updating a database element corresponding to the UID value (for the user device 10 or user 8) to indicate an instance of displaying an on-line advertisement corresponding to the on-line ad ID in the received notification from the user device 10.

Turning to FIG. 4, steps are summarized that are associated with a general process of administering, by the survey participant server 15, survey requests from the user device 10, for on-line surveys relating to on-line ad campaigns. The on-line surveys relate to on-line advertisements that are potentially displayed on the user device 10. The user 8 is classified as being in an “exposed” group or “control” group based upon whether the database element corresponding to the UID for the user device 10 indicates that a related on-line advertisement was previously displayed on the user device 10. Such exposure information arises from execution of the sequence of steps described herein above with reference to FIG. 3.

Initially, during step 200, the browser running on the user device 10 requests and receives a requested Web page from the Web server 12. The received Web page includes code (advertisement tag) identifying a source for an on-line advertisement block from the advertisement server 14.

In the exemplary embodiment, during step 205, the browser processes the Web page containing the advertisement tag and requests/receives the on-line advertisement block, from the advertisement server 14, containing the on-line advertisement 20. However, instead of (or in addition to) the tracking tag 22, the on-line advertisement block includes a survey participant recruitment tag including a survey ID.

After receiving the on-line advertisement block, during step 210, the browser on the user device 10 commences processing the requested/received on-line ad block. The processing of the on-line advertisement 20 of the advertisement block by the browser on the user device 10 results in the browser building/issuing an HTTP survey request for submission to the survey participant server 15. The HTTP survey request potentially relates to one or more surveys for advertisement campaigns. In an exemplary embodiment, the request includes: (1) an advertisement ID (corresponding to the on-line advertisement requested/received during step 205), (2) a survey ID, and (3) the UID associated with the user device 10 (or user 8). The user device 10 issues the HTTP survey request to the survey participant server 15 in the form of, for example, a URL including a set of appended parameters (e.g., the ad ID, survey ID and UID). The UID enables the survey participant server to access the database element containing a historical summary of the on-line ad exposure of the user device 10 corresponding to the provided UID value.

Thereafter, during step 215 the survey participant server 15 processes the on-line survey request issued by the user device 10. Such processing includes, among other things, selecting a particular survey, and classifying the survey participant (as either a control or exposed group member) based upon the provided survey ID and the historical on-line ad exposure information contained within the database element corresponding to the provided UID (for the user device 10 or user 8).

It can thus be seen that a new and useful method and system for administering on-line advertisement campaigns and conducting related on-line surveys have been described. In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that the elements of the illustrative embodiment shown in software, comprising computer-executable instructions stored on computer-readable media (including non-transitory computer-readable media), may be implemented in hardware and vice versa or that the illustrative embodiment can be modified in arrangement and detail without departing from the spirit of the invention. Therefore, the invention as described herein contemplates all such embodiments as may come within the scope of the following claims and equivalents thereof.

What is claimed is:

1. A method for administering on-line advertisement campaigns on a network including a user device having a unique identification (UID), a survey participant server and an advertisement server, the method comprising:
creating, on the survey participant server, a database element associated with the UID of the user device, the database element including information corresponding to on-line advertisements previously executed on the user device;
receiving, by the survey participant server, an on-line advertisement exposure notification from the user device, the on-line advertisement exposure notification including the UID and an on-line advertisement ID corresponding to an on-line advertisement provided by the advertisement server; and
updating, by the survey participant server, the database element associated with the UID in accordance with advertisement exposure on the user device associated with the on-line advertisement ID.

2. The method of claim 1 further comprising:
designating an on-line survey for presentation to the user device based upon the information stored in the database element, associated with the UID of the user device, corresponding to on-line advertisements previously executed on the user device.

3. The method of claim 1 wherein the UID is stored in a browser cache of the user device, and wherein the UID stored in the browser cache of the user device is accessed by a browser and sent to the survey participant server within the on-line advertisement exposure notification.

4. The method of claim 1 wherein the UID is stored in a local storage of the user device, wherein the local storage supports access to information via name-value pairs of data, and
wherein the UID stored in the local storage of the user device is accessed and sent to the survey participant server within the on-line advertisement exposure notification.

5. The method of claim 1 wherein the UID is provided by an on-line advertisement server to the survey participant server.

6. The method of claim 1 wherein the UID is a telecom company unique identifier assigned to the user device.

7. The method of claim 1 wherein the UID is a physical device-specific unique identifier assigned to the user device.

8. A non-transitory computer-readable medium including computer-executable instructions for administering on-line advertisement campaigns on a network including a user device having a unique identification (UID), a survey participant server and an advertisement server, the computer-executable instructions facilitating performing a method comprising:
creating, on the survey participant server, a database element associated with the UID of the user device, the database element including information corresponding to on-line advertisements previously executed on the user device;
receiving, by the survey participant server, an on-line advertisement exposure notification from the user device, the on-line advertisement exposure notification including the UID and an on-line advertisement ID corresponding to an on-line advertisement provided by the advertisement server; and
updating, by the survey participant server, the database element associated with the UID in accordance with advertisement exposure on the user device associated with the on-line advertisement ID.

9. The non-transitory computer-readable medium of claim 8 further comprising computer-executable instructions for:
designating an on-line survey for presentation to the user device based upon the information stored in the database element, associated with the UID of the user device, corresponding to on-line advertisements previously executed on the user device.

10. The non-transitory computer-readable medium of claim 8 wherein the UID is stored in a browser cache of the user device, and wherein the UID stored in the browser cache of the user device is accessed by a browser and sent to the survey participant server within the on-line advertisement exposure notification.

11. The non-transitory computer-readable medium of claim 8 wherein the UID is stored in a local storage of the user device, wherein the local storage supports access to information via name-value pairs of data, and
wherein the UID stored in the local storage of the user device is accessed and sent to the survey participant server within the on-line advertisement exposure notification.

12. The non-transitory computer-readable medium of claim 8 wherein the UID is provided by an on-line advertisement server to the survey participant server.

13. The non-transitory computer-readable medium of claim 8 wherein the UID is a telecom company unique identifier assigned to the user device.

14. The non-transitory computer-readable medium of claim 8 wherein the UID is a physical device-specific unique identifier assigned to the user device.

15. A networked computer system comprising one or more programmed processors and configured by computer-executable instructions stored on a computer-readable medium to carry out a method including:
creating, on the survey participant server, a database element associated with the UID of the user device, the database element including information corresponding to on-line advertisements previously executed on the user device;
receiving, by the survey participant server, an on-line advertisement exposure notification from the user device, the on-line advertisement exposure notification including the UID and an on-line advertisement ID corresponding to an on-line advertisement provided by the advertisement server; and
updating, by the survey participant server, the database element associated with the UID in accordance with advertisement exposure on the user device associated with the on-line advertisement ID.

16. The system of claim 15 wherein the survey participant server further comprises computer-executable instructions for:
designating an on-line survey for presentation to the user device based upon the information stored in the database element, associated with the UID of the user device, corresponding to on-line advertisements previously executed on the user device.

17. The system of claim 15 wherein the UID is stored in a browser cache of the user device, and wherein the UID stored in the browser cache of the user device is accessed by a browser and sent to the survey participant server within the on-line advertisement exposure notification.

18. The system of claim 15 wherein the UID is stored in a local storage of the user device, wherein the local storage supports access to information via name-value pairs of data, and
wherein the UID stored in the local storage of the user device is accessed and sent to the survey participant server within the on-line advertisement exposure notification.

19. The system of claim 15 wherein the UID is provided by an on-line advertisement server to the survey participant server.

20. The system of claim 15 wherein the UID is a telecom company unique identifier assigned to the user device.

21. The system of claim 15 wherein the UID is a physical device-specific unique identifier assigned to the user device.
